(19) United States
(12) Patent Application Publication
(10) Pub. No.: US 2025/0218304 A1
(43) Pub. Date: Jul. 3, 2025

(54) Artificial Intelligence-Based System, Application, and Method for Coaching Actors

(71) Applicant: Gini Woods, Calgary (CA)

(72) Inventor: Gini Woods, Calgary (CA)

(21) Appl. No.: 19/006,369

(22) Filed: Dec. 31, 2024

Related U.S. Application Data
(60) Provisional application No. 63/616,906, filed on Jan. 2, 2024.

(51) Int. Cl. G09B 5/02; G06T 11/00; G06V 20/40; G06V 40/20

(52) U.S. Cl. CPC G09B 5/02; G06T 11/00; G06V 20/41; G06V 40/20

(57) ABSTRACT

An AI-based acting and filmmaking and creative industry coaching system and associated mobile application is disclosed. The application is communicatively coupled to a server system which includes at least one AI-module for reviewing videos, audios, and other media uploaded by a user using the application. The system is adapted to provide feedback to a user based on review of the media and recommend different genres for improvement. The system provides VR videos based on uploaded scripts, data and videos for training. The application provides a plurality of tutorials for teaching every type of acting technique, filmmaking, scriptwriting, producing, directing, and more. The application functions as an artificial intelligence instructor that provides feedback on auditions and assignments the actor or creative industry user can submit through the application for review and feedback. The mobile application integrates AI and virtual reality to provide real-time feedback and instruction for filmmaking and creative industries.

### CROSS-REFERENCE TO RELATED APPLICATION

The present application claims priority to, and the benefit of, U.S. Provisional Application No. 63/616,906, which was filed on Jan. 2, 2024, and is incorporated herein by reference in its entirety.

### FIELD OF THE INVENTION

The present invention generally relates to the field of training and coaching systems and methods. More specifically, the present invention relates to a software application that functions as an artificial intelligence (AI) instructor to give education, feedback, and assignments to aspiring actors and other industry professionals. The application provides feedback and tutorials to teach every type of acting technique, filmmaking technique, script writing techniques, producing, directing, post production, fashion design, music making, singing, and more. The application enables users to upload auditions and assignments to get feedback from the AI. Accordingly, the present disclosure makes specific reference thereto. Nonetheless, it is to be appreciated that aspects of the present invention are also equally applicable to other like applications, devices, and methods of manufacture. The AI software provides real-time feedback and instruction. It is designed for a filmmaking and creative industry application (i.e., app) where users can explore and study various aspects of the filmmaking industry, including music, fashion, design, costume design, and more creative studies to include, but not limited to, Arts & Humanities, Media & Communications, Architecture & Urban Planning, Design & Technology, Performing Arts, Creative Technologies, Creative Business & Entrepreneurship, Transdisciplinary Creative Programs, Therapeutic Arts, Culinary Arts, Creative Education, Creative Technology and Digital Art And More. Users will be able to obtain certificates, diplomas and/or degrees in said programs. The software enables users to enhance their filmmaking process and create audio, video, and media content directly within the app, without needing to leave the platform. It supports every step of the filmmaking journey, from preproduction and development to post-production and release. Users can upload themselves as AI working professionals on the app. The AI will analyze the user's work, thereby enabling them to earn residual income by being part of (i.e., hired by) the app.

The AI within the software will assist users in filmmaking, education, and film viewing by interpreting a range of physical, emotional, and behavioral indicators. It will analyze facial expressions, voice tone, body language, and speech patterns to gauge emotional states, stress levels, and cognitive load. The AI will track user interactions, such as typing speed and browsing behavior, to assess engagement and satisfaction. In filmmaking, it will provide feedback on acting performances, scriptwriting, and production techniques by understanding emotional context and intentions. For users studying film, AI will offer insights into character development, storytelling, and film analysis. Additionally, the software will enhance the film-watching experience by adapting content recommendations based on mood and emotional reactions, helping users better engage with educational material and entertainment.

The app integrates VR, AI, and real-time tracking to create an immersive, adaptive experience for filmmaking, education, streaming, and social media. In filmmaking, AI and VR allow for interactive storytelling, where the narrative changes based on user emotions, choices, and engagement. Filmmakers can use AI-driven analytics to optimize scenes and understand viewer reactions. In education, the app personalizes learning by adjusting content based on the user's emotional and cognitive states, providing real-time feedback and immersive experiences that adapt to each learner's progress. For streaming, AI curates personalized content based on emotional responses and behavioral data, while VR enhances viewer engagement with interactive, immersive content. The app also integrates social media, enabling immersive VR interactions where AI moderates behavior and tailors content to users' emotional states. Comprehensive AI profiles track user behavior, adapting the experience across all platforms to maintain emotional engagement and enhance learning, entertainment, and social interactions.

### BACKGROUND

By way of background, acting, scriptwriting, filmmaking, fashion design, and music production and other creative industries require a considerable amount of training and practice. Professionals of such fields are continually required to refine their skills through both formal education and practical experience. Traditionally, acting training, direction training, script writing training, and more are conducted in group settings, where learners navigate the nuances of group dynamics. Conventional training includes collaboration with peers, conflict resolution, and adapting to various interpersonal interactions.

However, individuals find it challenging to locate quality training centers and further, the trainings are expensive. Additionally, traditional training methods do not always provide the individualized attention that students require to excel. Personalized feedback is generally not provided and generalized feedback is given to the users. Furthermore, such training methods are not scalable and cannot be used by all the professionals. There is a growing interest in an improved training method which may leverage artificial intelligence (AI) technology to revolutionize training in such creative fields.

Therefore, there exists a long-felt need in the art for artificial intelligence (AI) technology-based training methods for aspiring actors and other industry professionals. There is also a long-felt need in the art for a novel software application that functions as an artificial intelligence (AI) instructor to give education, feedback, and assignments to aspiring actors and other industry professionals. Additionally, there is a long-felt need in the art for an AI-based software application that teaches every type of acting technique, filmmaking technique, script writing techniques, producing, directing, post production, fashion design, music making, singing, and more. There is also a long-felt need in the art for an AI-based coaching system that provides personalized feedback to actors, singers, directors, and more. Further, there is a long-felt need in the art for an application that enables users to upload their media for review and feedback and which provides personalized feedback to the users. Furthermore, there is a long-felt need in the art for an acting coaching software application that can be used by actors, casting directors, producers, directors, scriptwriters, and others in the TV and film industry plus other creative industries for training, socializing, and more. Finally, there is a long-felt need in the arts for a mobile application that provides comprehensive and personalized training to entertainment and creative industry professionals.

The subject matter disclosed and claimed herein, in one embodiment thereof, comprises an artificial intelligence-based acting and creative industry coaching system. The system includes a software application, a server system communicatively connected to the software application via a communication network, the server system includes a video analysis module adapted to analyze visual components including expressions, body language, and attire from videos uploaded by users, an audio analysis module configured to analyze audio elements such as voice modulation and pitch from the user's video, a virtual reality (VR) module configured to generate a customized VR environment for performance simulation based on inputs like scripts or videos, an AI-driven dialogue module employs natural language processing to generate dialogues and scenes from scripts provided by users, and an AI module is personalized for individual users based on their profiles and historical data and provides tailored recommendations, tutoring, and user-specific personalization (i.e., feedback). A tutorial module is designed to provide educational content in various formats including videos, text, and live presentations, covering diverse categories such as filmmaking, production, direction, music, arts, media and acting methods. The software application provides different interfaces for enabling a user to upload media such as video, audio, script, and more for feedback.

In this manner, the artificial intelligence-based acting coaching system and application of the present invention accomplish all of the foregoing objectives and provide an application that functions as an artificial intelligence (AI) instructor that gives education, feedback, and assignments to aspiring actors and other creative industry professionals. The system through the application teaches every type of acting technique, filmmaking technique, script writing techniques, producing, directing, post production, fashion design, music making, singing, and more. The application enables users to upload auditions and assignments to get feedback from the AI. The application can be used by actors, casting directors, producers, directors, scriptwriters, and others and obviates group coaching. The AI software provides real-time feedback and instruction. It is designed for a filmmaking and creative industry application (i.e., app) where users can explore and study various aspects of the filmmaking and creative industry, including music, fashion, design, costume design, and more. The software enables users to enhance their filmmaking and creative industry process and create audio, video, and media content directly with the app, without needing to leave the platform. It supports every step of the filmmaking and creative industry journey, from preproduction and development to post-production and release. It is to be appreciated that AI software can be used for creating audio, video, and media productions without the expense of full-scale production, while providing the means for ease of file sharing. Users can upload themselves as AI working professionals on the app. The AI will analyze the user's work, thereby enabling them to earn residual income by being part of (i.e., hired by) the app. Uploading content on the app enables revenue streams, thereby providing a user a means to earn income and gain exposure without significant costs.

This software and app design is to provide access to study all fields in the creative industry and will democratize education by removing traditional barriers like high tuition fees, student loans, and geographic location. This would make learning accessible to a broader, more diverse group of people, regardless of financial resources or where they live. By offering flexible, affordable, and comprehensive resources, it would allow individuals to develop skills at their own pace, fostering a more inclusive and innovative creative workforce. The result is a society where talent is nurtured based on potential, not privilege, opening up new opportunities for personal growth and professional success.

By integrating AI and VR with advanced emotional, behavioral, and physical tracking, your filmmaking, educational, streaming, and social media platforms can create highly personalized, immersive experiences that adapt to users' emotional and cognitive states in real-time. Whether for immersive storytelling, personalized learning, dynamic social interactions, or emotional content curation, the combination of VR and AI will open up vast possibilities for creating engaging, responsive, and emotionally intelligent digital ecosystems.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an artificial intelligence-based system for coaching in the entertainment and creative industry. The system includes a software application adapted to be installed on an electronic computing device, a server system accessible by the software application through a communication network, wherein the server system includes a cloud-based server configured to provide artificial intelligence-based coaching functionalities, and an artificial intelligence module housed within the server system configured to analyze user input data and provide educational content, feedback, tutorials, and assignments to users.

In a preferred embodiment, the system includes a VR module within the server system and receives input selected from the group consisting of text, video, and audio, and the VR module is adapted to automatically generate a VR environment based on the received input.

In another embodiment, an artificial intelligence-based acting coaching system is disclosed. The system includes a software application, a server system communicatively connected to the software application via a communication network, and a video analysis module housed within the server system is adapted to analyze visual components including expressions, body language, and attire from videos uploaded by users, an audio analysis module housed within the server system is configured to analyze audio elements such as voice modulation and pitch from the user's video, a virtual reality (VR) module is configured to generate a customized VR environment for performance simulation based on inputs like scripts or videos, an AI-driven dialogue module employs natural language processing to generate dialogues and scenes from scripts provided by users, and an AI module is personalized for individual users based on their profiles and historical data and provides tailored recommendations, tutoring, and user-specific personalization (i.e., feedback).

In another aspect, a method for training and providing feedback to entertainment and creative industry professionals, implemented on a computing device comprises receiving video and audio input from a user via a software application, analyzing the video and audio input using an artificial intelligence-based server system to determine expressions, body language, attire, voice modulation, and pitch, generating feedback based on the analysis, and providing the generated feedback to the user through the software application.

In yet another embodiment, a method for generating automatic AI-based suggestions for users for training is described. The method includes the steps of creating a user profile on a software application on an electronic computing device by a user from a group consisting of actors and directors, uploading media including videos and script documents via the software application for training and feedback, analyzing the uploaded media and the user's historical performance data using multiple modules within a server system, and generating recommendations by an AI engine housed within the server system for future roles and genres based on the analysis, and providing tailored tutorials for user growth.

In another embodiment, a digital training (i.e., live training) and feedback system for performing artists and directors is disclosed. The system enables users to create personalized profiles and upload training media through a software application, employ a server system to analyze both newly uploaded and historically accumulated performance data across different media types, utilize an AI engine within the server system to automatically generate personalized suggestions for career development and skill enhancement, and offer real-time performance feedback through analysis of user activities.

In another embodiment, the application provides a script upload interface for receiving scripts from users, an artificial intelligence-driven dialogue module configured to analyze the uploaded scripts and generate dialogues and scenes and the interface provides real-time acting feedback as users perform the generated scenes.

In another aspect, the system includes an artificial intelligence recommendation engine configured to analyze the user data and generate personalized tutorials and role recommendations.

In another aspect, the AI software provides real-time feedback and instruction to enhance the filmmaking process and create audio, video, and media content directly with the app, without needing to leave the platform. It supports every step of the filmmaking journey, from preproduction and development to post-production and release.

In another aspect, the AI software can be used for creating audio, video, and media productions without the expense of full-scale production, while providing the means for case of file sharing. Users can upload themselves as AI working professionals on the app. The AI will analyze the user's work, thereby enabling them to earn residual income by being part of (i.e., hired by) the app. Uploading content on the app enables revenue streams, thereby providing a user a means to earn income and gain exposure without significant costs.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the artificial intelligence-based acting coaching system of the present invention in accordance with the disclosed architecture;

FIG. 2 illustrates the sign-up interface displayed by the AI-based acting coach application in accordance with one embodiment of the present invention;

FIG. 3 illustrates another user interface displayed by the application generating an AI-based feedback video along with insights for a user such as an actor in accordance with one embodiment of the present invention;

FIG. 4 illustrates another user interface displayed by the mobile application for automatically generating an AI-generated video based on a script in accordance with disclosed architecture;

FIG. 5 illustrates an exemplary user interface displayed by the application providing additional functionalities to a user of the system in accordance with one embodiment of the present invention;

FIG. 6 illustrates a user interface of the acting coach application of the present invention configured to display different types of tutorials available to the users in accordance with one embodiment of the present invention;

FIG. 7 illustrates a flow chart depicting a process of generation of automatic AI-based suggestions for users by the system in accordance with one embodiment of the present invention;

FIG. 8 illustrates a flow chart depicting a process of providing feedback to an actor based on a script in accordance with one embodiment of the present invention; and

FIG. 9 illustrates an exemplary personalized user interface displayed by the acting coaching application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for artificial intelligence (AI) technology-based training methods for aspiring actors and other creative industry professionals. There is also a long-felt need in the art for a novel software application that functions as an artificial intelligence (AI) instructor to give education, feedback, and assignments to aspiring actors and other industry professionals. Additionally, there is a long-felt need in the art for an AI-based software application that teaches every type of acting technique, filmmaking technique, script writing techniques, producing, directing, post production, fashion design, music making, singing, and more. There is also a long-felt need in the art for an AI-based coaching system that provides personalized feedback to actors, singers, directors, and more. Further, there is a long-felt need in the art for an application that enables users to upload their media for review and feedback and which provides personalized feedback to the users. Furthermore, there is a long-felt need in the art for an acting coaching software application that can be used by actors, casting directors, producers, directors, scriptwriters, filmmakers, production assistants, and others in the TV and film industry and other creative industries for training, socializing, and more. Finally, there is a long-felt need in the art for a mobile application that provides comprehensive and personalized training to entertainment and creative industry professionals.

The present invention, in one exemplary embodiment, is an artificial intelligence-based system for coaching in the entertainment and creative industries. The system includes a software application adapted to be installed on an electronic computing device, a server system accessible by the software application through a communication network, wherein the server system includes a cloud-based server configured to provide artificial intelligence-based coaching functionalities, and an artificial intelligence module housed within the server system configured to analyze user input data and provide educational content, feedback, tutorials, and assignments to users. The software application is AI-enabled and enables users to upload their media for feedback and training wherein, the application provides personalized feedback to the users for improving their performance.

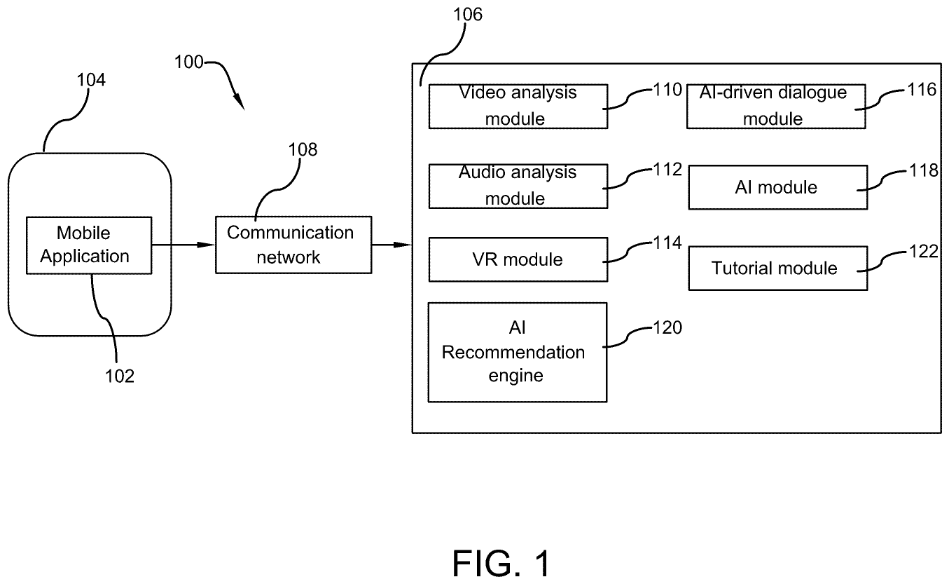

Referring initially to the drawings, FIG. 1 illustrates a schematic view of the artificial intelligence-based acting coaching system of the present invention in accordance with the disclosed architecture. The artificial intelligence-based acting coaching system 100 is designed to provide an artificial intelligence (AI) instructor for providing education, feedback, tutorials, and assignments to actors, directors, scriptwriters, and other industry professionals. More specifically, the acting coaching system 100 provides a software application 102 which is preferably in the form of a mobile application but can also be a desktop application. The software application 102 is installed in an electronic computing device 104 such as a smartphone, tablet, or a laptop. The software application 102 provides a plurality of functionalities for providing feedback, recommendations, tutoring, and more to aspiring actors and other professionals.

The system 100 includes a server system 106 and the software application 102 can access the features offered by the server system 106 via the communication network 108. In the preferred embodiment, the AI-based functionalities are offered in the server 106 which can be a cloud-based server. Alternatively, the system 100 can be designed by running the AI functionality directly on the user device 104. In some embodiments, the system 100 may implement a hybrid approach where Core AI processing and large data storage can be handled on server 106 while real-time, low-latency tasks such as live feedback during performance of a user can be processed locally on the user device 102.

The server system 106 includes a video analysis module 110 which is adapted to analyze the expressions, body language, attire, and more of a user (actor) in the video received by the system 100 from a user. It should be noted that a live video or a recorded video can be uploaded by a user for training and feedback. An audio analysis module 112 is adapted to monitor voice modulation, pitch of sound, and more of the actor in a video.

A virtual reality (VR) module 114 is adapted to provide a customized VR environment which is automatically generated based on a text such as a script or based on a video or audio (i.e., subject matter). The VR module 114 helps in creating a realistic environment for an actor to perform scenes. An AI-drive dialogue module 116 is configured to provide dialogues and different scenes based on a script uploaded by a user of the system. The module 116 uses natural language processing (NLP) and automatically generates different characters and corresponding dialogues from the script. The module 116 helps in training of an actor and helps scriptwriters to visualize the scenes.

An AI module 118 is the central module of the system 100 and is trained based on a profile of a user. The AI module 118 is personalized based on historical data related to the user and based on the personalized preferences. The AI module 118 is adapted to continuously receive data from the other modules such as video analysis module 110, audio analysis module 112, and more for providing recommendations, tutoring, and personalization (i.e., feedback) to the users of the system 100.

An AI-recommendation engine 120 is adapted to provide automatic recommendations for actors, directors and more based on a script. More specifically, the engine 120 matches the characteristics and preferences of different users of the system 100 for recommendations. The system 100 can be used as a marketplace to find actors, scriptwriters, directors, and more. A tutorial module 122 is configured to provide tutorials including videos, text, live shows, and more for actors and other professionals and be based on different categories including, but not limited to, filmmaking, production, direction, acting methods, and more.

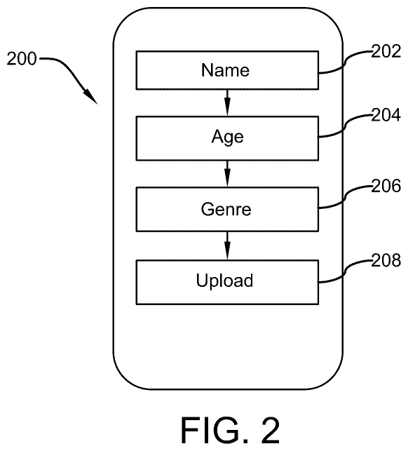

FIG. 2 illustrates the sign-up interface displayed by the AI-based acting coach application 102 in accordance with one embodiment of the present invention. As illustrated, the interface 200 enables a user to input name 202, age 204, preferred genre(s) 206, and one or more videos or images using the upload button 208 to create a personalized profile. It will be apparent to a person skilled in the art that the user can select one or more genres related to movies, music, and more. The uploaded media files and the genres are used by the server system 106 for creating a personalized profile of the user which can be used for providing tutorials and recommendations to the user. The profile of the user is continuously updated based on the interaction of the user with the application 102.

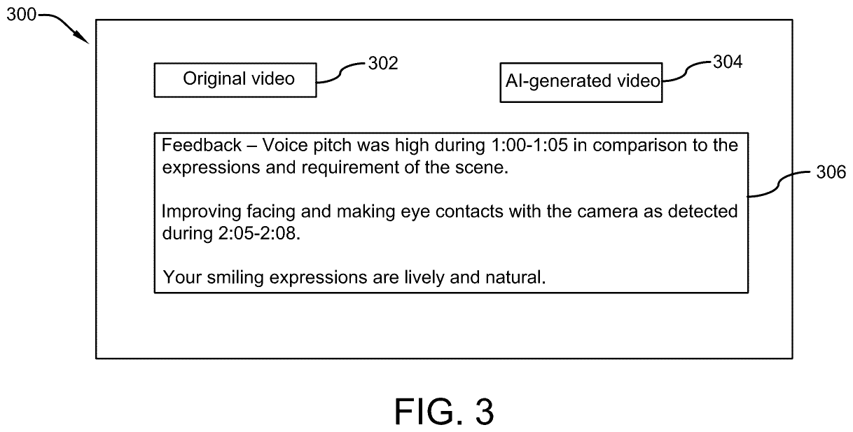

FIG. 3 illustrates another user interface displayed by the application 102 generating an AI-based feedback video along with insights for a user such as an actor in accordance with one embodiment of the present invention. The interface 300 displays an original video 302 uploaded by a user. The video can be a live video or a recorded video and can be any type of acting or dancing video. Different modules of the AI-based server system 106 analyze the uploaded video and identify the expressions, voice, and body movements which can be compared with historical data and other training data with the server 106. Based on the analysis of the uploaded video 302, the interface 300 displays an AI-generated video 304 which can be in the form of a feedback video for the uploaded video. The AI-generated video 304 preferably includes modified expressions, audio, or other characteristics for training the user of the uploaded video.

Along with the feedback video, a feedback notice 306 is also provided to the user which includes specific feedback points for the actor/user to improve. The AI module 118 uses the trained data of the same genre of the video in addition to analysis of different modules for providing feedback for training the user.

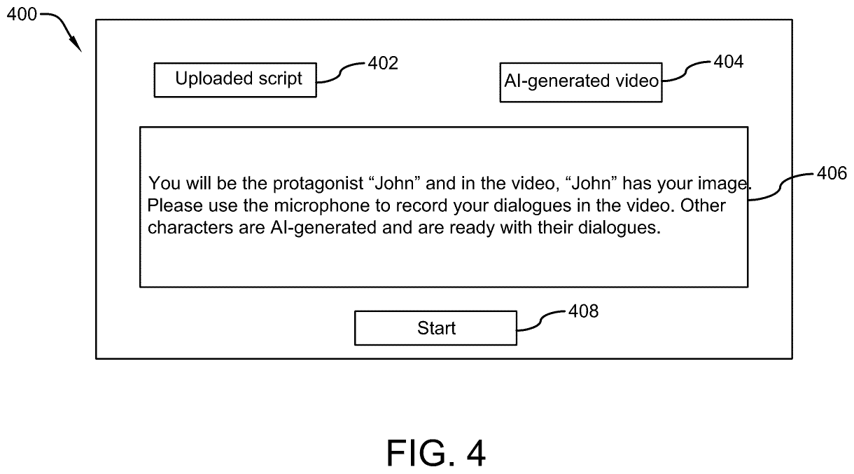

FIG. 4 illustrates another user interface displayed by the mobile application for automatically generating an AI-generated video based on a script in accordance with disclosed architecture. The application 102 enables a user such as a scriptwriter or an actor to upload a script using the upload script bar 402. Based on the uploaded script, the server 106 uses natural language processing (NLP) techniques to understand the characters, context, scenarios, emotions, and more and automatically generate a video which is displayed through the tab 404.

For providing training to the actor, the interface 400 provides recommendations to the actor to play a role in the generated video. All the characters in the video have corresponding AI-generated dialogues and the actor can replace one or more characters by replicating or replacing the dialogues as per the instructions 406. The start button 408 enables the user such as an actor to start the video and accordingly do training with the video.

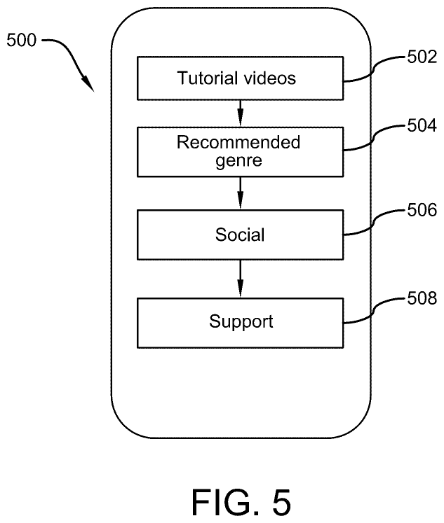

FIG. 5 illustrates an exemplary user interface displayed by the application 102 providing additional functionalities to a user of the system in accordance with one embodiment of the present invention. As illustrated, the interface 500 provides a tutorial video tab 502 which when selected displays a plurality of tutorial videos corresponding to different segments of the filmmaking and acting process and related to entertainment industry in general. The videos can be AI-generated and can also be contributed by other users of the system 100.

A recommended genre tab 504 provides at least one personalized genre based on the preferences and historical activities of a user. The recommended genre tab 504 uses the AI engine to automatically generate different genres in which the user is proficient and the genres in which the user needs improvement. A social tab 506 provides social networking within the application 102 and enables a user to talk/chat with other similar users who are into the same genre. The social tab 506 can recommend different directors to actors, for example for enabling the actors to work with directors and vice versa. A support tab 508 provides positive messages and may provide mental health support to the users of the system. The support tab 508 provides a wellness and mindfulness aspect of the system 100 to the users.

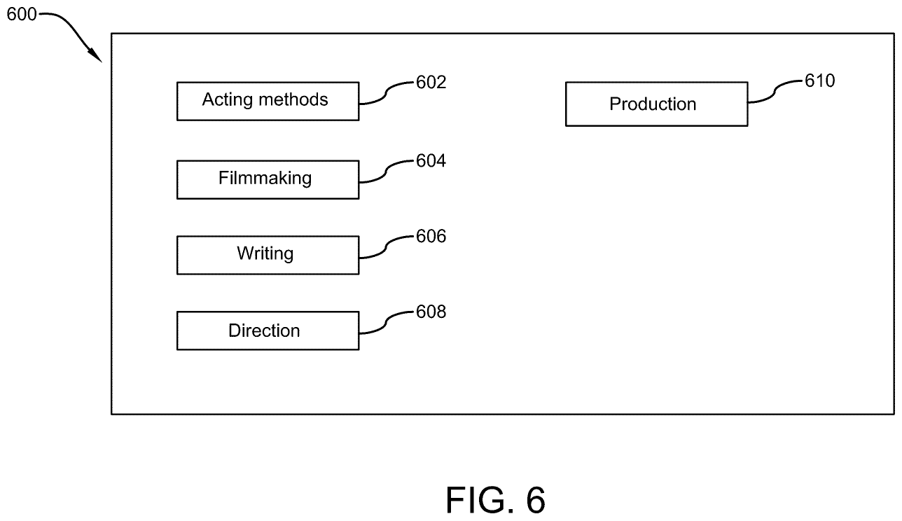

FIG. 6 illustrates a user interface of the acting coach application of the present invention configured to display different types of tutorials available to the users in accordance with one embodiment of the present invention. The interface 600 displays different categories that are automatically generated by the AI-based server system 106. The categories can be automatically generated based on the genres and preferences of the users of the system 100. The system 100 functions as a comprehensive coach for the individuals related to entertainment industry and the categories include all the tasks/profiles related to the profession.

As illustrated, the display 600 provides tutorials related to acting methods 602, filmmaking 604, writing 606, direction 608, and production 610. Additional categories can be added and further, the tutorials can include video tutorials, documents, documentaries, expert videos, and more.

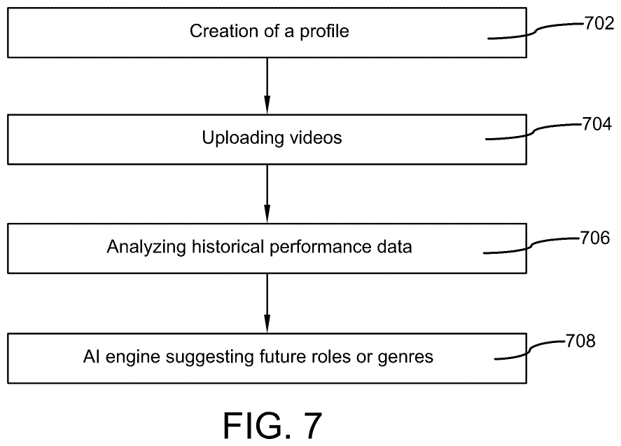

FIG. 7 illustrates a flow chart depicting a process of generation of automatic AI-based suggestions for users by the system in accordance with one embodiment of the present invention. Initially, a user such as an actor, director, and the like, creates a profile using the application 102 such as described in FIG. 2 (Step 702). Then, the user uploads videos and other media such as script documents and more for training and feedback (Step 704).

The server system 106 analyzes the historical performance data of the user by analyzing all the uploaded media along with the profile. The uploaded media are analyzed by different modules of the server system 106 (Step 706). The AI engine recommends future roles, genres, and more based on the analysis and provides tutorials for growth of the user (Step 708).

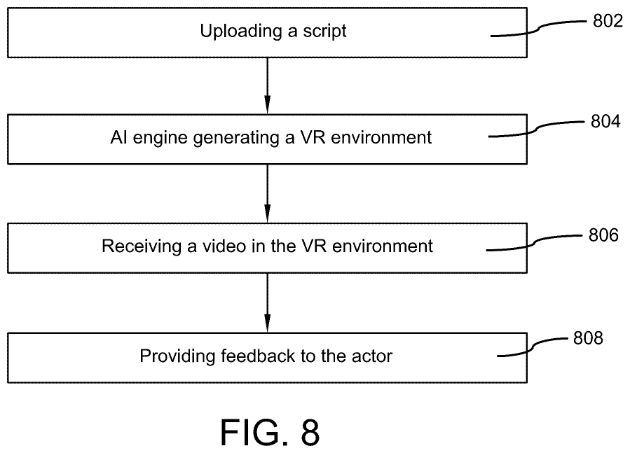

FIG. 8 illustrates a flow chart depicting a process of providing feedback to an actor based on a script in accordance with one embodiment of the present invention. Initially, a user such as an actor uploads a script for a show to the application 102 (Step 802). Then, based on the script, the system 100 understands the context, scenario, and other details, and the AI engine 118 along with the VR module 114 creates a video with VR environment (Step 804). Then, the actor performs acting using a headset, camera, or any other imaging device and updates the video with their dialogue and acting (Step 806). Finally, based on the received updated video, the system 100 provides feedback on the acting of the user (Step 808).

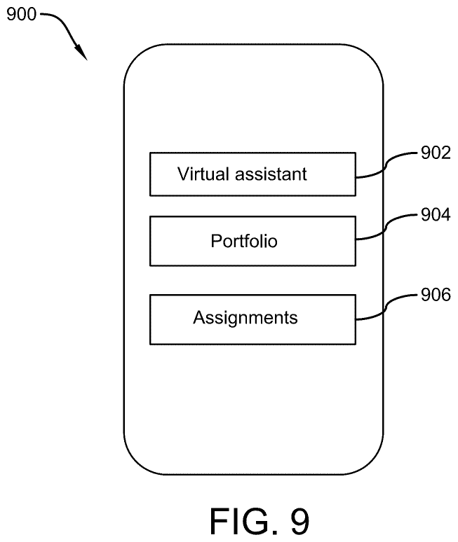

FIG. 9 illustrates an exemplary personalized user interface displayed by the acting coaching application of the present invention in accordance with the disclosed architecture. The user interface 900 provides a personalized virtual assistant 902 which can be in the form of a bot for providing response to queries of the user. The assistant 902 is also adapted to provide feedback to the user based on analysis of media content of the user.

The application 102 maintains a portfolio including images, videos, scripts, and more of users and can be accessed using portfolio button 904. The portfolio can be public or private depending on preferences of the user and can also be accessed by producers and directors for potential collaboration. The system 100 can also provide automatic assignments based on a profile of the user and can be accessed using the Assignments button 906. The assignments can be for including, but not limited to, making a short film, writing a script, singing a song, and more.

In addition, the application 102 provides for a step-by-step algorithm for enabling AI and virtual reality (VR) filmmaking. The application 102 includes a user interaction that provides the following exemplary interactive steps to create a film: the user selects “Make a Film”, AI avatar introduces itself and explains the filmmaking process, and user selects the type of project (e.g., movie, TV show, training video, commercial, music video, web series). The project setup provides the following exemplary interactive steps: the user chooses a genre and theme for the project, AI generates a storyboard and script outline based on user input, the user reviews and modifies the storyboard and script as needed, and user connects with scriptwriters and other collaborators through the application 102. Character and scene creation can include the following steps: the user selects or creates characters using AI tools, AI generates character models and animations, the user customizes characters' appearance and behavior, the user selects or creates scenes using VR tools, and AI generates virtual environments and sets. The filmmaking process can include the following steps: the user directs scenes by positioning characters and setting camera angles in the VR environment, AI assists with real-time adjustments and suggestions, the user records scenes using VR tools, and AI processes and edits recorded footage, adding special effects and transitions. Post production can include the following steps: the user reviews the edited film and makes final adjustments, AI provides options for color grading, sound design, and music integration, the user selects and customizes these options, and AI finalizes the film, ensuring all elements are cohesive and polished. Distribution of the film can include the following steps: the user selects distribution platforms (e.g., YouTube, Vimeo, streaming services), AI optimizes the film for each platform, and user uploads the film directly from the application 102. Global collaboration of the film can include the following steps: the user selects the option to collaborate with other users globally, AI matches users based on project needs and preferences, and users can communicate and collaborate in real-time using integrated VR and AI tools. Real and AI actors can be added to the film including the following steps: the user chooses to hire real actors or AI-generated actors, for real actors, AI facilitates casting calls and auditions; for AI actors, the user customizes the AI-generated characters, and AI integrates real and AI actors into the project seamlessly.

Further, the users can upload themselves as AI working professionals on the application 102. The AI will analyze their work, enabling them to earn residual income by being hired within the application 102 (i.e., the app). The process can include AI analyzing the following physical indicators such as body language, posture, gestures, facial expressions, and eye contact. The process can include AI analyzing the following physiological responses such as heart rate, breathing patterns, and sweating. Emotional indicators can be analyzed such as tone of voice, pitch, volume, and pace. Emotional energy indicators can be analyzed such as intensity and consistency. Behavioral indicators can be analyzed such as speech content, word choice, and topics of interest.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically-performed step may or may not be automatic.

Furthermore, one or more examples described herein may be implemented through the use of instructions that are executable by one or more processors. These instructions may be carried out on a computer-readable medium. Examples of computer-readable mediums include permanent memory-storage devices, such as hard drives on personal computers or servers. Other examples of computer-storage mediums include portable storage units, such as CD or DVD units, flash memory drives (such as carried on smartphones, multifunctional devices, or tablets), and magnetic memory devices. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer-usable carrier medium capable of carrying such a program.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “AI-based acting coach application”, “software application”, “mobile application”, and “application” are interchangeable and refer to the AI-based acting coach application 102 of the present invention. Similarly, as used herein, “artificial intelligence based acting coaching system”, “acting coaching system”, and “system” are interchangeable and refer to the artificial intelligence based acting coaching system 100 of the present invention.

Notwithstanding the foregoing, the artificial intelligence based acting coaching system 100 and the AI-based acting coach application 102 of the present invention can include any additional components to enhance the functionality and efficiency of the artificial intelligence-based acting coaching system 100 and the AI-based acting coach application 102. One of ordinary skill in the art will appreciate that the configuration and components of the artificial intelligence-based acting coaching system 100 and the AI-based acting coach application 102, as shown in the FIGS., are for illustrative purposes only and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An acting coaching system comprising:
a software application;
an electronic computing device;
a server system;
a communication network;
a video analysis module;
an audio analysis module;
a virtual reality module;
an AI-drive dialogue module;
a script; and
an AI module;
wherein said software application accesses said server system;
wherein said video analysis module analyzes video actions of a user;
wherein said video actions are selected from the group consisting of an expression, a body language, an attire, and a body movement;
wherein said audio analysis module analyzes audio of the user;
wherein said audio is selected from the group consisting of a voice modulation and a pitch of sound of the user;
wherein said virtual reality (VR) module provides a customized VR environment automatically generated based on said script;
wherein said script is selected from the group consisting of a text of said script, a video of said script, and an audio of said script;
wherein said AI-drive dialogue module provides dialogues and scenes to the user based on said script;
wherein said AI module receives data selected from the group consisting of said video analysis module, said audio analysis module, said VR module, and said AI-drive dialogue module; and
further wherein said AI module provides feedback to the user based on said data received to said AI module.

2. The acting coaching system of claim 1, wherein said AI-drive dialogue module having natural language processing (NLP) for generating characters and corresponding said dialogues from said script.

3. The acting coaching system of claim 1, wherein said feedback is selected from the group consisting of providing recommendations, tutoring, and personalization to the user.

4. The acting coaching system of claim 1 further comprising an AI-recommendation engine for searching and recommending matches for said script.

5. The acting coaching system of claim 4, wherein said matches is selected from the group consisting of an actor, a director, a scriptwriter, a filmmaker, a producer and a production assistant.

6. The acting coaching system of claim 5 further comprising a tutorial module for providing a tutorial selected from the group consisting of a tutorial video, a tutorial text, and a tutorial live show.

7. The acting coaching system of claim 6, wherein said tutorial including a category selected from the group consisting of a filmmaking, a production, a direction, and an acting method.

8. The acting coaching system of claim 7, wherein said software application having a sign-up interface for inputting personal information selected from the group consisting of the user's name, the user's age, the user's preferred genre, the user's profile video, and the user's profile image to create a personalized profile.

9. The acting coaching system of claim 8, wherein the user's preferred genre is selected from the group consisting of a movie and a music.

10. The acting coaching system of claim 9, wherein said personalized profile searched by said tutorial module for matching said tutorial to said personalized profile.

11. The acting coaching system of claim 10, wherein said software application is a mobile application.

12. An acting coaching system comprising:
a software application;
an electronic computing device;
a server system;
a communication network;
a video analysis module;
an audio analysis module;
a virtual reality module;
an AI-drive dialogue module;
a script; and
an AI module;
wherein said software application accesses said server system;
wherein said video analysis module analyzes video actions of a user;
wherein said video actions are selected from the group consisting of an expression, a body language, an attire, and a body movement;
wherein said audio analysis module analyzes audio of the user;
wherein said virtual reality (VR) module provides a customized VR environment automatically generated based on said script;
wherein said script is selected from the group consisting of a text of said script, a video of said script, and an audio of said script;
wherein said AI-drive dialogue module provides dialogues and scenes to the user based on said script;
wherein said AI-drive dialogue module recommends a role to the user based on said script;
wherein said AI module receives data selected from the group consisting of said video analysis module, said audio analysis module, said VR module, and said AI-drive dialogue module; and
further wherein said AI module provides feedback to the user based on said data received to said AI module.

13. The acting coaching system of claim 12, wherein said AI-drive dialogue module having natural language processing (NLP) for generating characters and corresponding said dialogues from said script.

14. The acting coaching system of claim 12, wherein said feedback is selected from the group consisting of providing recommendations, tutoring, and personalization to the user.

15. The acting coaching system of claim 12 further comprising an AI-recommendation engine for searching and recommending matches for said script.

16. The acting coaching system of claim 15, wherein said matches is selected from the group consisting of an actor, a director, a scriptwriter, a filmmaker, and a producer.

17. The acting coaching system of claim 12 further comprising a tutorial module for providing a tutorial selected from the group consisting of a tutorial video, a tutorial text, and a tutorial live show.

18. The acting coaching system of claim 17, wherein said tutorial including a category selected from the group consisting of a filmmaking, a production, a direction, and an acting method.

19. The acting coaching system of claim 18, wherein said software application having a sign-up interface for inputting personal information selected from the group consisting of the user's name, the user's age, the user's preferred genre, the user's profile video, and the user's profile image to create a personalized profile.

20. A method of coaching filmmaking, the method comprising the steps of:
providing a software application, an electronic computing device, a server system, a communication network, a video analysis module, an audio analysis module, a virtual reality (VR) module, an AI-drive dialogue module, a script, and an AI module, wherein said software application accesses said server system;
selecting a type of film project;
setting up said film project;
choosing a genre and a theme for said film project;
generating a storyboard and a script outline based on user inputs and user reviews;
modifying said storyboard and said script;
providing a customized VR environment based on said script with said virtual reality (VR) module, wherein said script is selected from the group consisting of a text of said script, a video of said script, and an audio of said script, wherein said AI-drive dialogue module provides dialogues and scenes to said user based on said script;
creating characters by selecting one or more from the group consisting of a character's appearance and behavior;
modifying said scenes by selecting one or more from the group consisting of a scene's camera angle and environment;
recording said scenes;
receiving data with said AI module, wherein said data is selected from the group consisting of said video analysis module, said audio analysis module, said VR module, and said AI-drive dialogue module;
providing feedback to said user with said AI module based on said data received to said AI module;
reviewing said scenes;
editing said scenes into said film project;
distributing said film project; and
uploading said film project from said software application.
